(19) United States
(12) Patent Application Publication
(10) Pub. No.: US 2019/0291325 A1
(43) Pub. Date: Sep. 26, 2019

(54) EXTRUSION SYSTEM, EXTRUDER AND METHOD FOR COATING WIRES, CABLE PRE-PRODUCTS OR STRANDED CONDUCTORS

(71) Applicant: LEONI KABEL GMBH, NUERNBERG (DE)

(72) Inventors: JOERG THIEDE, GEHLENBERG (DE); BENEDIKT ENGLER, OLDENBURG (DE)

(73) Assignee: LEONI KABEL GMBH, NUERNBERG (DE)

(21) Appl. No.: 16/464,683

(22) PCT Filed: Nov. 22, 2017
(86) PCT No.: PCT/DE2017/101005

§ 371 Date: May 29, 2019

(30) Foreign Application Priority Data
Dec. 8, 2016 (DE) 10 2016 123 736.1

(51) Int. Cl. B29C 48/154; B29C 48/325; B29C 48/92

(52) U.S. Cl. CPC B29C 48/154; B29C 48/325; B29C 2948/92152; B29C 2948/92076; B29C 2948/92123; B29C 48/92

(57) ABSTRACT

An extrusion apparatus to sheathe wires, semi-finished products for cables, or stranded wires. The extrusion apparatus includes an extrusion head and a motorized adjustment device. The extrusion head includes a molding die and a semi-finished product guide having an aperture. The semi-finished product guide and the molding die are arranged with respect to each other so that a molding compound can be formed into an extruded molded product through the aperture of the semi-finished product guide via the molding die. The motorized adjustment device is moved by an actuating signal. The motorized adjustment device is assigned to the semi-finished produce guide and/or to the molding die so that the semi-finished product guide and the molding die can be aligned with respect to each other by moving the motorized adjustment device via applying the actuating signal.

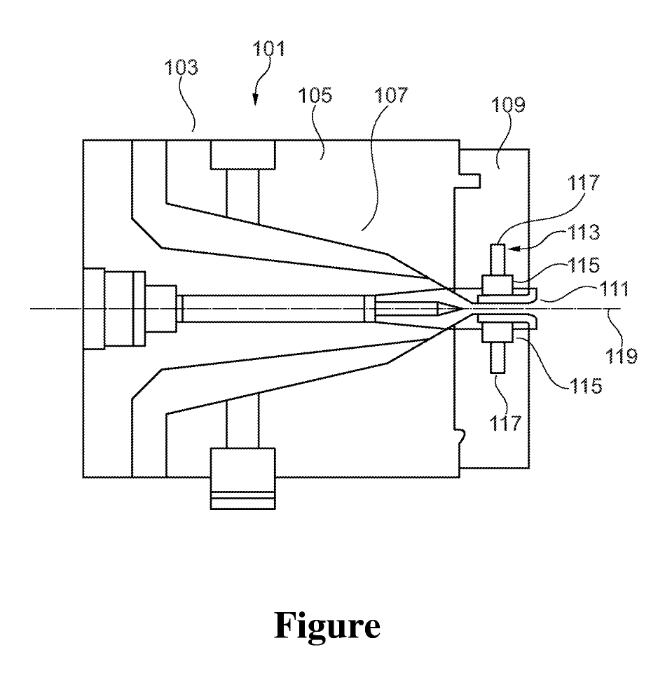

### CROSS REFERENCE TO PRIOR APPLICATIONS

This application is a U.S. National Phase application under 35 U.S.C. § 371 of International Application No. PCT/DE2017/101005, filed on Nov. 22, 2017 and which claims benefit to German Patent Application No. 10 2016 123 736.1, filed on Dec. 8, 2016. The International Application was published in German on Jun. 14, 2018 as WO 2018/103785 A1 under PCT Article 21(2).

### FIELD

The present invention relates to an extrusion apparatus to sheathe wires, semi-finished products for cables, or stranded wires, where the extrusion apparatus has an extrusion head with a guide for semi-finished products and a molding die, whereby the semi-finished product guide and the molding die are arranged with respect to each other so that an aperture in the guide for semi-finished products can allow a molding compound to be formed into an extruded molded part by the molding die. The present invention also relates to an extruder and to a method to sheathe wires, semi-finished cable products, or stranded wires.

### BACKGROUND

The extrusion is carried out by continuously pressing usually solid to molten curable masses under pressure and/or at a raised temperature through a molding die into a long molded part via a nozzle. Extrusion is used to sheathe wires, semi-finished products for cables, or stranded wires, for example, whereby the sheath of the molded mass is applied to the wires, semi-finished cable products or stranded wires.

During the extrusion process, even the smallest differences in temperature and/or pressure and the necessity to manufacture within very narrow tolerances lead to a situation where the first 200 m to 500 m of the sheathed wires, semi-finished cable products or stranded wires must often be discarded as scrap.

It is particularly important with extrusion that the aperture of the semi-finished product guide be optimally aligned with the molding die. The sheathing must also be applied with radial homogeneity around the wire, semi-finished cable product or stranded wire, and the centering and longitudinal axis.

When sheathing electrical conductors (wires and stranded wires), the centering of the semi-finished product guide and/or the molding die is usually carried out manually. The alignment of the molding die is here carried out via a centering plate which is mounted onto the extrusion head with the semi-finished product guide. Bolt positions on the centering plate are used to tilt the centering plate and hence the molding die. The fact that the adjustment is restricted to tilting and is manual means that the alignment of the semi-finished produce guide and the molding die with respect to each other is not fine enough to achieve the requisite, very low manufacturing tolerances.

DE 692 11 772 T2 describes an extrusion apparatus to sheathe wires, semi-finished cable products or stranded wires, where the extrusion apparatus has an extrusion head with a guide for semi-finished products and a molding die.

Servomotors whose motions can be used to align two centering devices with respect to each other are described in U.S. Pat. No. 5,795,531. A method is also disclosed where a wire passing through is fed into the extrusion head.

U.S. Pat. No. 4,551,087 describes a method to compare the thicknesses achieved with a target thickness of an insulation layer, whereby the thickness of the insulation layer can be changed by adjustment tools on an extrusion apparatus.

DE 10 2008 061 286 A1 describes an extrusion apparatus to produce tubular hollow parts or sheathings, which has a position-adjustable nozzle close to an extruding nozzle.

A device with an extrusion head which has a nozzle, an inlet nozzle, and an outlet nozzle through which to feed an electrical conductor and thereby sheathe the electrical conductor with an insulation layer is described in U.S. Pat. No. 4,668,173.

DE 87 04 664 U1 describes a device with a centering device to produce pipes, whereby the centering device has movable wedges and a measuring device is assigned to the centering device which checks the wall thickness distribution.

DE 10 2014 103 101 A1 describes a device which is suitable for producing blow-molded plastic hollow bodies, where tubular preforms are extruded simultaneously from several extrusion tools of a multi-extrusion head, said extrusion tools being arranged adjacent to each other, and are fed to blow-molding cavities of a closing unit.

### SUMMARY

An aspect of the present invention is to improve upon the prior art.

In an embodiment, the present invention provides an extrusion apparatus to sheathe wires, semi-finished products for cables, or stranded wires. The extrusion apparatus includes an extrusion head and a motorized adjustment device. The extrusion head comprises a molding die and a semi-finished product guide which comprises an aperture. The semi-finished product guide and the molding die are arranged with respect to each other so that a molding compound can be formed into an extruded molded product through the aperture of the semi-finished product guide via the molding die. The motorized adjustment device is configured to be moved by an actuating signal. The motorized adjustment device is assigned to at least one of the semi-finished produce guide and to the molding die so that the semi-finished product guide and the molding die can be aligned with respect to each other by moving the motorized adjustment device via an application of the actuating signal.

### BRIEF DESCRIPTION OF THE DRAWING

The present invention is described in greater detail below on the basis of embodiments and of the drawing in which:

The FIGURE shows a schematic cross-sectional view of an extrusion apparatus with an extrusion head, a semi-finished product guide, a nozzle and a centering device.

### DETAILED DESCRIPTION

In an embodiment, the present invention provides an extrusion apparatus to sheathe wires, semi-finished products for cables, or stranded wires, where the extrusion apparatus has an extrusion head with a guide for semi-finished products and a molding die, whereby the semi-finished product guide and the molding die are arranged with respect to each other so that a molding compound can be formed to an extruded molded product by the molding die through an aperture in the semi-finished product guide, and a motorized adjustment device is assigned to the semi-finished produce guide and/or the molding die so that the semi-finished product guide and the molding die can be aligned with respect to each other by moving the motorized adjustment device if an actuating signal is applied to the motorized adjustment device.

By aligning the semi-finished product guide and the molding die with respect to each other via the motorized adjustment device, a finer adjustment is possible so that better centricity values and thus better product characteristics are achieved. Better reproducibility of the product qualities is also achieved.

It is particularly advantageous that a faster alignment of the semi-finished product guide and the molding with each other is carried out during the running-in and also when production parameters change or faults occur. The consumption of materials, the quantity rejected, and the quantity of waste to be disposed of (scrap) can be reduced.

By applying the actuating signal, a very accurate, automatic centering of the extrusion head and/or the molding die is facilitated.

It is moreover advantageous compared to the prior art that a tilting centering plate of a front plate of the extrusion head is superfluous and the motorized adjustment device itself and/or the front plate must no longer be firmly fixed, but can be arranged separately, for example, on a sliding rail. This affords better access to the adjustment device and/or front plate and thus makes replacement easier.

One important concept of the present invention is based on the fact that by applying an actuating signal to the motorized adjustment device, a very defined and fine alignment of the semi-finished product guide and the molding die with respect to each other is achieved via a movement of the motorized adjustment device which this signal brings about.

It is particularly advantageous that a direct linear proportionality exists between the actuating signal applied and the adjustment movement of the motorized adjustment device.

The following terminology is explained in the present invention:

An “extrusion apparatus” is in particular a device to extrude a molding compound through a semi-finished product guide and a molding die to form an extruded molded part. An extrusion apparatus is in particular a device to sheathe wires, semi-finished cable products or stranded wires. Cold, warm and/or hot extrusion is in particular carried out via an extrusion apparatus. The extrusion apparatus in particular operates at a pressure of 10 bar to 1,500 bar and a temperature of 10° C. to 500° C. An extrusion apparatus can in particular also be a device for extruding pipes, profiles and/or films, and also for rod extrusion. An extrusion apparatus in particular includes an extrusion head, a semi-finished product guide, a molding die and/or a separate or integrated front plate for the extrusion head. The extrusion apparatus can in particular be the extrusion head directly, which comprises the molding die in addition to the semi-finished product guide.

A “wire” is in particular a thin, long and/or flexibly formed metal with a circular cross-section. The wire may also be a flat, square or be a profiled wire. A wire is in particular comprised of copper, aluminum or a copper alloy.

A “stranded wire” is an electrical conductor which consists of thin individual wires and is particularly easy to bend. In contrast to inflexible, single-stranded and/or multi-stranded wires, a stranded wire is in particular also called a fine or ultra-fine conductor. In RF stranded wires, the individual wires are insulated from each other in particular by a layer of lacquer. A stranded wire in particular contains copper. The individual strands of the stranded wire are in particular enclosed by a common insulating sheath (stranded wire cable). Several stranded lines which are combined in a cable are in particular called cores. A stranded wire has a thickness of 0.004 mm to 4 mm.

A “core” is in particular an individual conductor within a bundle of a cable. A core is usually an insulated wire or a stranded wire. A single core or multi-core assembly of cores which is sheathed by insulating materials in particular forms a “semi-finished product for cables”. A core in particular has copper, aluminum, silver, steel and/or lead as its conductor material. A core in particular has a thickness of 0.1 mm to 15 mm.

“Sheathing” is in particular taken to mean the extruding (spraying) of a sheath around the outside of a wire, semi-finished product for cables, or a stranded wire. The sheathing in particular serves to insulate and/or shield the wire, the semi-finished product for cables, or the stranded wire. Synthetic materials such as polyolefins, polyurethane, polyvinyl chloride, polytetrafluoroethylene (PTFE) and/or silicone are in particular used as the molding compound for the sheathing.

An “extrusion head” is in particular a component which accommodates the molten molding compound under pressure and feeds it via flow channels to the semi-finished product guide. An extrusion head can at the same time in particular accommodate an ingoing material running through it, such as a wire, a semi-finished cable product or a stranded wire. In addition to the semi-finished product guide, an extrusion head can in particular also comprise a molding die, or the molding die is assigned to the extrusion head. One or more extruders and/or one or more transport devices is or are arranged in the extrusion head to feed the molding compound.

A “semi-finished product guide” is in particular a nozzle with an aperture through which in particular a wire, a semi-finished cable product or a stranded wire is continuously guided and/or the molding compound is continuously pressed (extruded). A nozzle is in particular a tapering, tubular technical device with an aperture at the smallest tapered cross-section. A semi-finished product guide is in particular also a confuser. The semi-finished product guide can be an extrusion nozzle.

A “molding die” is in particular a tool which imposes a shape on the molding compound as it leaves the semi-finished product guide. A molding die is in particular also called a nozzle. The molding compound in particular flows through the inside of the molding die and thereby fills the inner shape of the molding die. When the ingoing materials running through are wires, semi-finished products for cables, or stranded wires, they are in particular guided through the molding die so as to be in the center, whereby the molding compound sheathes the exterior surface of the ingoing material and itself assumes the form of the inner surface of the molding die as its external surface.

A “motorized adjustment device” is in particular an adjustment device which is related to movement. A motorized adjustment device is in particular a device which executes and/or generates a movement. A motorized adjustment device in particular executes a linear elongation and/or movement. With a motorized adjustment device, the length of the linear motion (travel) is in particular proportional to an applied actuating signal. A motorized adjustment device is in particular a linear motor, an eccentric, a spindle adjustment and/or a piezoelectric actuator.

An “actuating signal” is in particular deemed to be an electric or pneumatic signal. An actuating signal is in particular a standardized unit signal, for example, a current signal of 0 mA to 20 mA or a voltage signal of 0 V to 10 V. By applying the actuating signal to the motorized adjustment device, a defined movement of the motorized adjustment device is in particular initiated. The actuating signal can be applied manually and/or automatically. The actuating signal can be increased incrementally, for example, by manually turning a rotary knob with graduation marks, the movement of the motorized adjustment device thus being incrementally extended. The actuating signal may also be applied automatically via a control and/or regulation device of the extrusion apparatus and/or an external device.

A “movement” is in particular a movement in a straight line or a movement on a curved trajectory of the motorized adjustment device, where a driven object, such as the molding die and/or semi-finished product guide, is again moved. A movement is in particular a change in position of the motorized adjustment device and/or the semi-finished product guide and/or the molding die.

“Alignment” in particular means a spatial arranging of the semi-finished product guide and the molding die with respect to each other so that a molding compound is optimally formed into an extruded molded part via the aperture of the semi-finished product guide and the molding die behind it. The alignment in particular also comprises the centering, where an alignment is made to the center or the central axis (centering axis) of components. The semi-finished product guide and the molding die are in particular aligned with respect to each other so that the eccentricity (as the measure of the deviation from the circular shape) of a finished molded part and/or a sheathed wire, semi-finished cable product or stranded wire, is low.

In an embodiment of the present invention, the extrusion apparatus can, for example, have a receptacle to accommodate an ingoing material passing through it, in particular a wire, a semi-finished cable product, or a stranded wire, so that the ingoing material can be sheathed with the molding compound.

This means that it is not only possible to achieve optimum alignment of the semi-finished product guide and the molding die with respect to each other, but that they can also be aligned with respect to an accommodated ingoing material which is passing through them.

It is thus possible to realize an optimum wire, stranded wire, core, sheath and/or cable extrusion.

To induce a uniform and/or spatially more complex movement, the motorized adjustment device has an alignment body where the alignment body has a mechanical functional connection with the molding die.

The molding die can thus be aligned by the motorized adjustment device moving with respect to the alignment body.

It is in particular favorable when the alignment body is a ring, so that a more complex radial alignment of the molding die can be realized.

The alignment body can alternatively also be arranged at the semi-finished product guide and the semi-finished product guide thus aligned. The semi-finished product can also be displaced appropriately so that a centering can be realized via the displacement.

In an embodiment of the present invention, the motorized adjustment device can, for example, be mounted at the semi-finished product guide, the molding die and/or the adjustment body.

This allows the free positioning of the motorized adjustment device to align the semi-finished product guide and/or the molding die. The motorized adjustment device can also act directly on the semi-finished product guide and/or the molding die and/or indirectly via the alignment body.

To generate a defined linear movement, the motorized adjustment device comprises a linear motor, an eccentric and/or a piezoelectric actuator.

The electric energy of the actuating signal can thus be converted directly into a mechanical, linear elongation and/or linear movement in the nanometer range via the linear motor, eccentric and/or the piezoelectric actuator.

When a piezoelectric actuator is used, the fact that it is temperature resistant up to 250° C. also means that production can take place at high temperatures and without affecting the product quality.

A “linear motor” is in particular an electric drive unit which shifts an object it drives on a straight or curved trajectory. A linear motor in particular generates a direct translational movement.

An “eccentric” is in particular a cam mounted on a shaft whose center is outside the shaft axis. An eccentric in particular converts rotational (turning) motions into translational (linear) motions.

A “piezoelectric actuator” is in particular a component which uses the piezoelectric effect to execute a mechanical movement when an electric voltage is applied. A piezoelectric actuator is in particular a piezoelectric stack with a sandwich construction. A piezoelectric actuator in particular comprises a piezo ceramic. The piezoelectric stack of a piezoelectric actuator is usually accommodated in a housing, where a prestress is in particular applied between housing and a piezo ceramic to prevent the object being driven from creating tensile forces. A piezoelectric actuator in particular has a guiding system, for example, a flexure joint. A piezoelectric actuator in particular causes a movement by virtue of its elongation.

To facilitate a fast and flexible alignment in the different spatial directions, the motorized adjustment device has a second linear motor, a second eccentric and/or a second piezoelectric actuator, a third linear motor, a third eccentric and/or a third piezoelectric actuator, a fourth linear motor, a fourth eccentric and/or a fourth piezoelectric actuator, and/or further linear motors, further eccentrics and/or further piezoelectric actuators.

Several movements from different directions can thus be used simultaneously to align the semi-finished product guide and the molding die with respect to each other.

It is in particular advantageous when four linear motors, eccentrics and/or piezoelectric actuators are arranged on the exterior of an alignment ring each at intervals of 90° from each other, said alignment ring being arranged around the molding die, for example, so that the centricity of the molding die can be set very quickly and precisely and/or the molding die can be aligned with respect to the centering axis of the extrusion apparatus.

A second, third, fourth and/or further linear motor corresponds to the above-defined linear motor in its function, although each individual linear motor is arranged at a different position in the extrusion apparatus.

A second, third, fourth and/or further eccentric corresponds to the above-defined eccentric in its function, although each individual eccentric is arranged at a different position in the extrusion apparatus.

A second, third, fourth and/or further piezoelectric actuator corresponds to the above-defined piezoelectric actuator in its function, although each individual piezoelectric actuator is arranged at a different position in the extrusion apparatus.

In an embodiment of the extrusion apparatus of the present invention, the linear motor, the eccentric and/or the piezoelectric actuator or the linear motors, the eccentrics and/or the piezoelectric actuators can, for example, have a travel in the range of 0.01 nm to 1 mm, for example, from 0.1 nm to 200 μm.

It is thus possible to achieve a very precise and very fine adjustment of the alignment of the semi-finished product guide and/or the molding die. Very low manufacturing tolerances of ±0.05 mm can thus be achieved and the product quality thus improved.

“Travel” is in particular the change in length of a piezoelectric actuator or the displacement path of a linear motor or eccentric.

In order to facilitate a continuous alignment and adjustment of the alignment of the semi-finished product guide and the molding die during manufacture, a measuring device to determine at least one measurand of an extruded molded part and/or a control and/or regulation device is or are assigned to the extrusion apparatus so that the adjustment signal can be applied to the motorized adjustment device as a function of the specific measurand.

This allows the actual centricity value of the molded part or of the sheath applied to the sheathed wire, semi-finished cable product or stranded wire to be registered continuously and be used, for example, to control and/or regulate the motorized adjustment device.

It is particularly advantageous that the external diameter, the ovality (out-of-roundness), wall thickness and eccentricity as well as the slant of a sheathed wire, semi-finished cable product or stranded wire can thus be determined and that a correction of these parameters can take place directly during manufacture via the extrusion apparatus and/or the steering and/or control device.

This can prevent the eccentricity from “running away” during manufacture and long-term oscillations can be compensated.

A “measuring device” is in particular the totality of all measurement instruments and additional equipment to obtain a measurement result. A measuring device in particular has one measuring instrument or several measuring instruments which are provided for the measurement of a measurand. A measuring device and/or a measuring instrument in particular has or have a primary detector (sensor). A measuring device is in particular an online measuring device for the non-contact and continuous measurement of cores, wires, stranded wires and/or cables. The measuring device in particular measures an eight-point eccentricity, four-axis diameter and/or eight-point ovality (out-of-roundness). The measuring device in particular has two optical measuring instruments and one inductive measuring instrument to measure the concentricity of a wire, semi-finished cable product or stranded wire in the insulation (sheath) and the product parameters external diameter, ovality (out-of-roundness) and wall thickness. The measuring device also in particular detects a slant of the wire, semi-finished cable product or stranded wire in one measurement plane and thus to the centering axis of the extrusion apparatus.

A “steering device” is in particular a device where system conditions cause one or more quantities as the input quantity to affect other quantities as output quantities. A steering device is in particular a device which intends to influence the behavior of the extrusion apparatus. The steering device in particular provides an actuating signal to the motorized adjustment device.

A “control device” is in particular a device in which a quantity is continuously recorded as the controlled quantity and compared with a different quantity as the reference quantity and is influenced depending on the result of this comparison to adjust it to the reference quantity. A control device in particular uses a closed control loop. When a control device is used, the target value, in particular, for example, the eccentricity specified, is compared with the measured actual eccentricity value of the measurement device (controlled quantity), and an actuating signal which is based on the deviation from the target value is applied to the motorized adjustment device by the control device to optimize the alignment of the semi-finished product guide and/or the molding die and thus achieve the target eccentricity value of a manufactured core or stranded wire.

A “measurand” is in particular the physical quantity which is being measured. The measurand was or is in particular the objective of a measurement. The measurand need not be directly the subject of the measurement, but can also be determined from a quantity or several quantities using the laws of physics and/or mathematics. The measurand is in particular a physical property of the extruded molded part or the sheathed wires, semi-finished products for cables, or stranded wires. The measurand is in particular the diameter, the ovality (out-of-roundness), wall thickness, concentricity, slant and/or bend of a wire, semi-finished product for cables, or stranded wire.

A further aspect of the present invention provides an extruder to sheathe wires, semi-finished products for cables, or stranded wires, where the extruder comprises an aforementioned extrusion apparatus.

An extruder with optimal steering and/or control of the extrusion process and to produce improved product characteristics via more exact centricity values or other desired product parameters is therefore provided.

The purpose of the extruder is primarily to achieve a reproducible quality for the extruded molded parts and sheathed wires, semi-finished products for cables, or stranded wires.

An “extruder” is in particular a manufacturing device for extrusion. An extruder is in particular a ram extruder or a screw extruder with one, two or more worm shafts. An extruder in particular has a drive, an extrusion head with a semi-finished product guide, a molding die, a front plate and/or a measuring device.

A further aspect of the present invention is to provide a method to sheathe wires, semi-finished products for cables, or stranded wires via the afore-described extrusion apparatus with an afore-described measuring device and/or an afore-described steering and/or control device and/or an afore-described extruder, comprising the following steps:
Introduce a wire, semi-finished cable product, or a stranded wire into the extrusion head which then passes though the extrusion head;
Extrude the molding compound through the semi-finished product guide and the molding die to form a sheathed wire, semi-finished cable product, or a sheathed stranded wire;
Determine at least one measurand of the sheathed wires, semi-finished cable products, or the sheathed stranded wire by means of the measuring device;
Use the measurand determined to generate the actuating signal;
Control and/or steer the motorized adjustment device by applying the actuating signal;
Move the motorized adjustment device with respect to the semi-finished product guide, the molding die and/or the alignment body;
Align the semi-finished product guide and/or the molding die with respect to each other; and
Extrude a centered sheathed wire, semi-finished cable product, or stranded wire.

This in particular provides a method to sheathe wires, semi-finished products for cables, or stranded wires, where at least one product characteristic of the manufactured sheathed wire, semi-finished cable product, or stranded wire is recorded on-line and/or continuously, the manufacturing process is adjusted by aligning the semi-finished product guide and the molding die with respect to each other, and is optimized to improve the quality of the manufactured product.

This production method thus allows the material consumption, the quantity rejected and the amount of waste to be reduced in addition to increasing the quality of the product. Manufacturing process malfunctions can also be identified and immediately compensated for.

The present invention is explained in greater detail below with the aid of an example embodiment as shown in the drawing.

An extrusion apparatus 101 comprises an extrusion head 103 with a head casing 105 and an interior semi-finished product guide 107. A front plate 109 is arranged on the extrusion head 103.

The front plate 109 has a centering fixture 113. The centering fixture 113 which comprises a nozzle 111, an alignment ring 115 and four piezoelectric actuators 117. The four piezoelectric actuators 117 are arranged at 90° intervals on the outside of the alignment ring 115 (the two piezoelectric actuators which extend into the drawing plane and out of the drawing plane are not shown for illustrative reasons).

A centering axis 119 is assigned to the extrusion apparatus 101. A (not illustrated) measuring device for the measurement of centricity is arranged behind the extrusion apparatus 101. A (not illustrated) control device is also part of the extrusion apparatus 101.

The following production steps are realized with the extrusion apparatus 101:

A stranded wire with 0.25 mm outer diameter is introduced into the extrusion head 103 and continuously passes through the extrusion head 103 and the nozzle 111. Molten polyethylene (PE) is pressed through the semi-finished product guide 107 and the nozzle 101 at a temperature of 220° C. and a pressure of 300 bar and sheathes the stranded wire which is passing through.

The centricity of the sheathed stranded wire manufactured is determined on-line and continuously via the (not illustrated) measuring device, for example, the Centerview 8000 from Sikora. The measurement states that an eccentricity compensation of 1.15 (maximum sheath thickness to minimum sheath thickness) is necessary. As a result, an actuating signal is generated by the (not illustrated) control device and forwarded to the centering device 113. As a result, the top piezoelectric actuator 117 executes a lifting movement of 150 μm with an actuator length of 45 mm against the alignment ring 115, whereby the nozzle 111 is aligned in relation to the centering axis 119 and the semi-finished product guide 107. A sheathed stranded wire with better centricity is subsequently extruded from the extrusion apparatus 101. The measuring device continuously repeats the determination of the centricity during manufacture.

A method to sheathe the stranded wire is thus provided which guarantees a radially and longitudinally uniform sheathing of the stranded wire and thus guarantees its functionality.

The present invention is not limited to embodiments described herein; reference should be had to the appended claims.

What is claimed is:

1-10. (canceled)

11. An extrusion apparatus to sheathe wires, semi-finished products for cables, or stranded wires, the extrusion apparatus comprising:
an extrusion head comprising a molding die and a semi-finished product guide which comprises an aperture, the semi-finished product guide and the molding die being arranged with respect to each other so that a molding compound can be formed into an extruded molded product through the aperture of the semi-finished product guide via the molding die; and
a motorized adjustment device which is configured to be moved by an actuating signal, the motorized adjustment device being assigned to at least one of the semi-finished produce guide and to the molding die so that the semi-finished product guide and the molding die can be aligned with respect to each other by moving the motorized adjustment device via an application of the actuating signal.

12. The extrusion apparatus as recited in claim 11, wherein the extrusion apparatus further comprises:
a receptacle configured to accommodate an ingoing material passing therethrough so that the ingoing material is sheathed with the molding compound.

13. The extrusion apparatus as recited in claim 12, wherein the ingoing material is a wire, a semi-finished cable product, or a stranded wire.

14. The extrusion apparatus as recited in claim 11, wherein the motorized adjustment device comprises an alignment body which comprises a mechanical functional connection with the molding die.

15. The extrusion apparatus as recited in claim 14, wherein the motorized adjustment device is mounted at least one of the semi-finished product guide, the molding die, and the alignment body.

16. The extrusion apparatus as recited in claim 11, wherein the motorized adjustment device comprises at least one of a first linear motor, a first eccentric, and a first piezoelectric actuator.

17. The extrusion apparatus as recited in claim 16, wherein the motorized adjustment device further comprises at least one of,
at least one of a second linear motor, a second eccentric, and a second piezoelectric actuator,
at least one of a third linear motor, a third eccentric, and a third piezoelectric actuator,
at least one of a fourth linear motor, a fourth eccentric, and a fourth piezoelectric actuator, and
at least one of further linear motors, further eccentrics, and further piezoelectric actuators.

18. The extrusion apparatus as recited in claim 17, wherein,
the at least one of the first linear motor, the first eccentric, and the first piezoelectric actuator,
the at least one of the second linear motor, the second eccentric, and the second piezoelectric actuator,
the at least one of the third linear motor, the third eccentric, and the third piezoelectric actuator,
the at least one of the fourth linear motor, the fourth eccentric, and the fourth piezoelectric actuator, and
the at least one of the further linear motors, the further eccentrics, and the further piezoelectric actuators,
has/have a travel range of 0.01 nm to 1 mm.

19. The extrusion apparatus as recited in claim 18, wherein the travel range is from 0.1 nm to 200 μn.

20. The extrusion apparatus as recited in claim 11, further comprising,
a measuring device configured to determine at least one measurand of an extruded molded part; and
at least one of a steering device and a control device,
wherein,
each of the respective measuring device, steering device and control device is assigned to the extrusion apparatus so that the actuating signal can be applied to the motorized adjustment device as a function of the at least one measurand.

21. An extruder configured to sheathe wires, semi-finished products for cables, or stranded wires, the extruder comprising the extrusion apparatus as recited in claim 11.

22. A method for sheathing wires, semi-finished products for cables, or stranded wires with the extruder as recited in claim 21, the method comprising:
introducing a wire, a semi-finished cable product, or a stranded wire into the extrusion head so that the wire, the semi-finished cable product, or the stranded wire passes through the extrusion head;
extruding the molding compound through the semi-finished product guide and the molding die to form a sheathed wire, a semi-finished cable product, or a sheathed stranded wire;
determining at least one measurand of the sheathed wire, the semi-finished cable product, or the sheathed stranded wire via the measuring device;
using the at least one measurand determined so as to generate the actuating signal;
at least one of controlling and steering the motorized adjustment device by applying the actuating signal;
moving the motorized adjustment device with respect to at least one of the semi-finished product guide, the molding die, and the alignment body;
aligning at least one of the semi-finished product guide and the molding die with respect to each other; and
extruding a centered sheathed wire, a centered semi-finished cable product, or a centered sheathed stranded wire.

23. A method for sheathing wires, semi-finished products for cables, or stranded wires via the extrusion apparatus as recited in claim 20, the method comprising:
introducing a wire, a semi-finished cable product, or a stranded wire into the extrusion head so that the wire, the semi-finished cable product, or the stranded wire passes through the extrusion head;
extruding the molding compound through the semi-finished product guide and the molding die to form a sheathed wire, a semi-finished cable product, or a sheathed stranded wire;
determining the at least one measurand of the sheathed wire, the semi-finished cable product, or the sheathed stranded wire via the measuring device;
using the at least one measurand determined so as to generate the actuating signal;
at least one of controlling and steering the motorized adjustment device by applying the actuating signal;
moving the motorized adjustment device with respect to at least one of the semi-finished product guide, the molding die, and the alignment body;
aligning at least one of the semi-finished product guide and the molding die with respect to each other; and
extruding a centered sheathed wire, a centered semi-finished cable product, or a centered sheathed stranded wire.
